(19) United States
(12) Patent Application Publication
(10) Pub. No.: US 2010/0200590 A1
(43) Pub. Date: Aug. 12, 2010

(54) Container Closure System

(76) Inventors: William S. Shadrach, III, Salt Lake City, UT (US); Aubi Abramowitz, Seattle, WA (US)

Correspondence Address: THORPE NORTH & WESTERN, LLP., P.O. Box 1219, SANDY, UT, 84091-1219, US

(21) Appl. No.: 12/762,744

(22) Filed: Apr. 19, 2010

Related U.S. Application Data
(63) Continuation of application No. 11/605,851, filed on Nov. 27, 2006.
Application No. 11/605,851 is a continuation-in-part of application No. 11/505,622, filed on Aug. 16, 2006.

(51) Int. Cl. B65D 51/18; B23P 11/00

(52) U.S. Cl. 220/254.9; 29/428

(57) ABSTRACT

A method of forming a lid for use on a container comprises obtaining a base configured to be attached to the container and forming a slide channel, including: forming as part of the base a pair of sidewalls defining lateral sides of the slide channel; and defining an open top section of the slide channel between upper portions of the sidewalls. A slidable portion can be inserted through the open top section and into the slide channel such that the slidable portion is slidably movable within the slide channel. The slidable portion can be positioning over the cover portion and the cover portion can be attached to the base.

### PRIORITY CLAIM

This application is a continuation of copending U.S. patent application Ser. No. 11/605,851, filed Nov. 27, 2006, which is a continuation-in-part of U.S. patent application Ser. No. 11/505,622, filed Aug. 16, 2006, each of which is hereby incorporated herein by reference in its entirety.

### BACKGROUND

Containers with which a reusable (or reclosable) dispensing opening closure is associated abound in present society. For example, packages, such as those in which powders (e.g., table salt, detergents, bath salts, etc.) are sold to consumers are often provided with a reusable closure in the form of an extendable spout formed of paperboard or metal. The spout can be “opened” by rotating a portion of the spout away from the container to allow contents of the container to be poured through the spout. The spout can be “closed” by rotating the portion of the spout to its original position against or inside the container to prevent (or at least limit) contents of the container from spilling from the container.

Another widely used example of containers of this type is the disposable cup utilized in selling beverage products such as coffee, tea, hot chocolate, etc. Conventional containers such as these often include a lid or cap that can be attached to the container after it has been filled with the beverage. The lid or cap often includes a reusable closure in the form of movable structure that allows the consumer to expose (e.g., “open”) a dispensing orifice in the lid or cap to allow the consumer to dispense (e.g., sip or drink) the beverage from the container. Many of the more sophisticated designs of such lids or caps include movable structure that can be “closed” after drinking the beverage to at least partially seal the lid or cap to limit spillage of the beverage.

While such reusable closure devices have been provided on beverage containers, or lids or caps of such containers, with some degree of success, conventional devices such as these often significantly increase the cost of the container and/or its lid or cap, and often do not provide a closure that can be repeatedly and reliably used a number of times. For example, most such conventional closures require that the container itself (or the lid or cap of the container) be formed with some type of receiving structure in order for the closure to be effectively integrated with the container. This feature can not only negatively affect the cost and effort required to manufacture the container or lid, it can increase the cost and effort required to install the closure on or in the container.

In addition, efforts to provide such containers with a closure that can be used multiple times throughout the product life of the container have resulted in closure systems that are overly complex. Such overly complex systems can both increase the costs associated with forming and attaching the closure systems and can result in a closure system that is not intuitive to use. The resulting closure system can confuse consumers, which might damage the system in attempting to use it, or the consumer may not appreciate and thereby enjoy the benefits of the system.

### SUMMARY

It has been recognized that it would be advantageous to develop a container lid closure system that can be easily attached to a wide variety of container lid designs, and that can be reliably and easily reused during the life cycle of the container lid.

The present invention provides a lid for use on a container, including a base, having attachment structure associated therewith for attaching the base to the container, and having a material dispensing orifice formed or formable therein. A slide channel can be formed as part of the base, the slide channel including an open top section defined by a pair of sidewalls. The open top section can have an opening width equal to or greater than a narrowest width defined between the pair of sidewalls. A slidable portion can be slidably disposed within the slide channel and can be movable at least partially over the material dispensing orifice. A cover portion can be attached to the base and can form a top of a slide enclosure for the slidable portion.

In accordance with another embodiment of the invention, a lid for use on a container is provided, including a base, having attachment structure associated therewith for attaching the base to the container and having a material dispensing orifice formed or formable therein. A slide channel can be formed as part of the base, the slide channel including an open top section bordered by a pair of sidewalls. A slidable portion can be slidably disposed within the slide channel and can be movable at least partially over the material dispensing orifice. A cover portion can be attached to the base. The cover portion can form a top of a slide enclosure for the slidable portion and can be in interfering contact with at least a portion of the slidable portion to both restrict the slidable portion from moving upwardly in the slide channel and to provide a braking interface with the slidable portion to at least partially restrict sliding movement of the slidable portion.

In accordance with another aspect of the invention, a lid for use on a container is provided, including a base, having attachment structure associated therewith for attaching the base to the container, and having a material dispensing orifice formed or formable therein. A slidable portion can be slidably disposed on the base and can be slidably movable at least partially over the material dispensing orifice. A cover portion can be welded to the base, the cover portion forming a slide enclosure for the slidable portion to substantially restrict the slidable portion to movement on the base in a single degree of freedom.

In accordance with another aspect of the invention, a lid for use on a container is provided, including a base, having attachment structure associated therewith for attaching the base to the container. A material dispensing orifice can be formed or formable in the base. A vent orifice can be formed or formable in the base. A moveable section can include blocking structure operable to at least partially block both of the material dispensing orifice and the vent orifice. Movement of the moveable section can effectuate: simultaneous blockage of the material dispensing orifice; and simultaneous unblocking of the material dispensing orifice and the vent orifice.

In accordance with another aspect of the invention, a method of forming a lid for use on a container is provided, including: obtaining a base configured to be attached to the container; forming a slide channel, including: forming as part of the base a pair of sidewalls defining lateral sides of the slide channel; and defining an open top section of the slide channel between upper portions of the sidewalls; inserting a slidable portion through the open top section and into the slide channel such that the slidable portion is slidably movable within the slide channel; and positioning over the slidable portion a cover portion and attaching the cover portion to the base.

In accordance with another aspect of the invention, a method of forming a lid for use on a container is provided, including: obtaining a base configured to be attached to the container; disposing a slidable portion in slidable contact with the base; positioning a cover portion over the slidable portion; and attaching the cover portion to the base to thereby form a slide enclosure to substantially restrict the slidable portion to movement in a single degree of freedom.

### BRIEF DESCRIPTION OF THE DRAWINGS

Reference will now be made to the exemplary embodiments illustrated, and specific language will be used herein to describe the same. It will nevertheless be understood that no limitation of the scope of the invention is thereby intended.

FIG. 1A is a top, plan view of a closure assembly in accordance with an embodiment of the invention;

FIG. 1B is a top, plan view of a closure assembly in accordance with another embodiment of the invention;

FIGS. 2A through 2C are a series of side, sectional views (taken along section 2-2 of FIG. 3A) showing a series of positions of the closure assembly of FIG. 1A as it is attached to a portion of a container;

FIG. 3A is a top, plan view of container lid or cap having the closure assembly of FIG. 1A attached thereto;

FIG. 3B is a top, plan view of container lid or cap having the closure assembly of FIG. 1B attached thereto;

FIG. 4 is a side, sectional view (taken along section 4-4 of FIG. 3A) of a container lid or cap with a closure assembly in accordance with the present invention attached thereto, with the closure assembly provided in a closed, secure configuration;

FIG. 4B is a side, sectional view of the container lid or cap of FIG. 4, with the closure assembly provided in an open, secure configuration;

FIG. 5 is a top, plan view of a portion of a container having the closure assembly of FIG. 1B attached thereto;

FIG. 6A is a perspective view of a base of a lid for use on a container in accordance with another aspect of the invention;

FIG. 6B is a perspective, partially exploded, view of the base of FIG. 6A with a slidable portion and a cover portion being associated therewith;

FIG. 6C is a perspective view of an assembled lid utilizing the components of FIG. 6B;

FIG. 7A is a cross sectional view of a base with a slide channel formed therein, with a slidable portion disposed in the slide channel and with a cover portion attached over the slidable portion;

FIG. 7B is a cross sectional view of the base and slide channel of FIG. 7A;

FIG. 8 is a cross sectional view of another base with a slide channel formed therein, with a slidable portion disposed within the slide channel and a cover portion attached over the slide channel and the slidable portion; and

FIG. 9 is a cross sectional view of a base with a slidable portion disposed thereon and a cover portion attached over the slidable portion.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention.

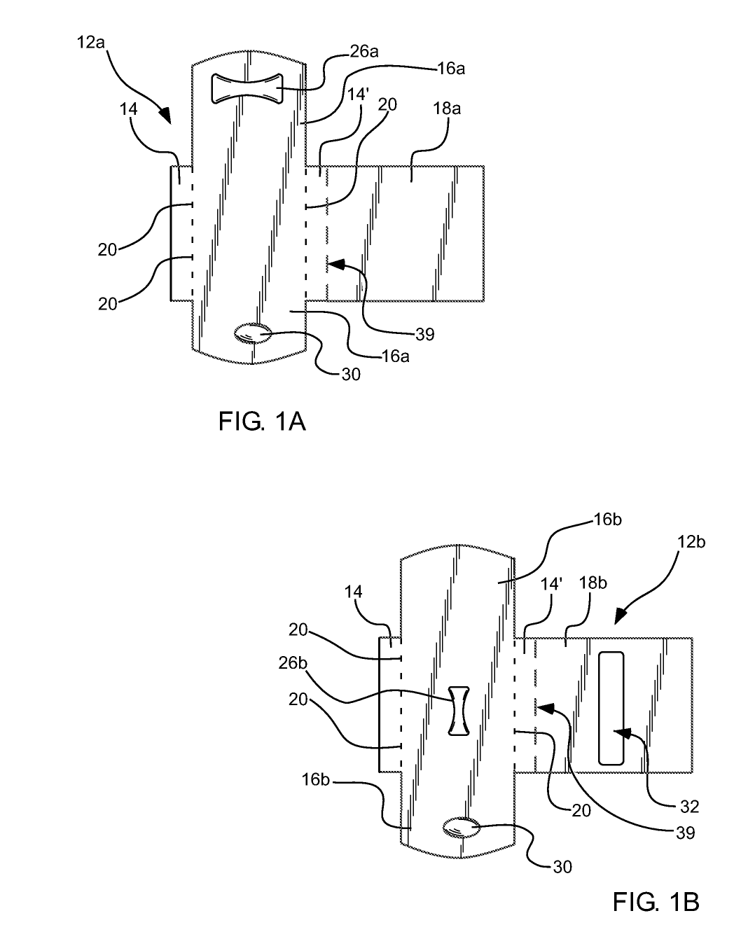

Thus, the following more detailed description of the embodiments of the present invention, as represented in FIGS. 1A through 5, is not intended to limit the scope of the invention, as claimed, but is presented for purposes of illustration only and to sufficiently enable one skilled in the art to practice the invention. Accordingly, the scope of the present invention is to be defined solely by the claims.

In describing and claiming the present invention, the following terminology will be used.

The singular forms “a,” “an,” and “the” include plural referents unless the context clearly dictates otherwise. Thus, for example, reference to “a control” includes reference to one or more of such controls, and reference to “an array” includes reference to one or more of such arrays.

As used herein, relative terms, such as “upper,” “lower,” “upwardly,” “downwardly,” etc., are used to refer to various components of containers, lids or caps of containers, or reusable closures for containers. It is to be understood that such terms in no way limit the present invention but are used to aid in describing the components of the reusable closures, and containers and/or lids and caps generally, in the most straightforward manner. When such terms are used in connection with beverage containers, it is to be understood that they are in reference to the generally accepted orientation of beverage containers when positioned for use. In such an orientation, the container is generally vertical with a lid or cap attached to an upper portion of the container.

As used herein, the term “substantially” refers to the complete or nearly complete extent or degree of an action, characteristic, property, state, structure, item, or result. For example, when an object or group of objects is/are referred to as being “substantially” liquid-tight, it is to be understood that the object or objects are either completely liquid-tight or are nearly completely liquid tight. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. For example, an opening that is “substantially free of” material would either completely lack material, or so nearly completely lack material that the effect would be the same as if it completely lacked material. In other words, an opening that is “substantially free of” material may still actually contain some such material as long as there is no measurable effect as a result thereof.

As used herein, the term “weld” is to be understood to refer to a relationship between two or more components in which the components have been joined by way of a process that at least partially intermixes material of the components. As an example, the process of ultrasonically welding two polymer components generally results in sections of material of the two components intermixing so as to be integrally joined with one another. Welding, as that term is used herein, can be accomplished by heating two or more materials to join the materials, or by chemically affecting the two or more materials to join the materials.

As used herein, the term “welding” is not intended to include processes by which two or more materials are attached to one another by conventional adhesives. However, some types of “adhesives” that chemically join two or more materials to one another by at least partially intermixing the two or more materials can be considered to “weld” the two or more materials to one another.

When discussed herein, apertures or orifices may be “formed or formable” in a structure, such as a base of a lid that is configured to be attached to a container. When an orifice is formed or formable in another structure, it is to be understood that such language includes the case where the structure includes an orifice formed therein, and also includes the case where features that facilitate formation of an orifice are formed therein. As an example of an orifice that is formable in a lid, some beverage container lids include a perforated “knock-out” section that can be relatively easily dislodged from the lid to form an orifice where the knock-out section was formerly located.

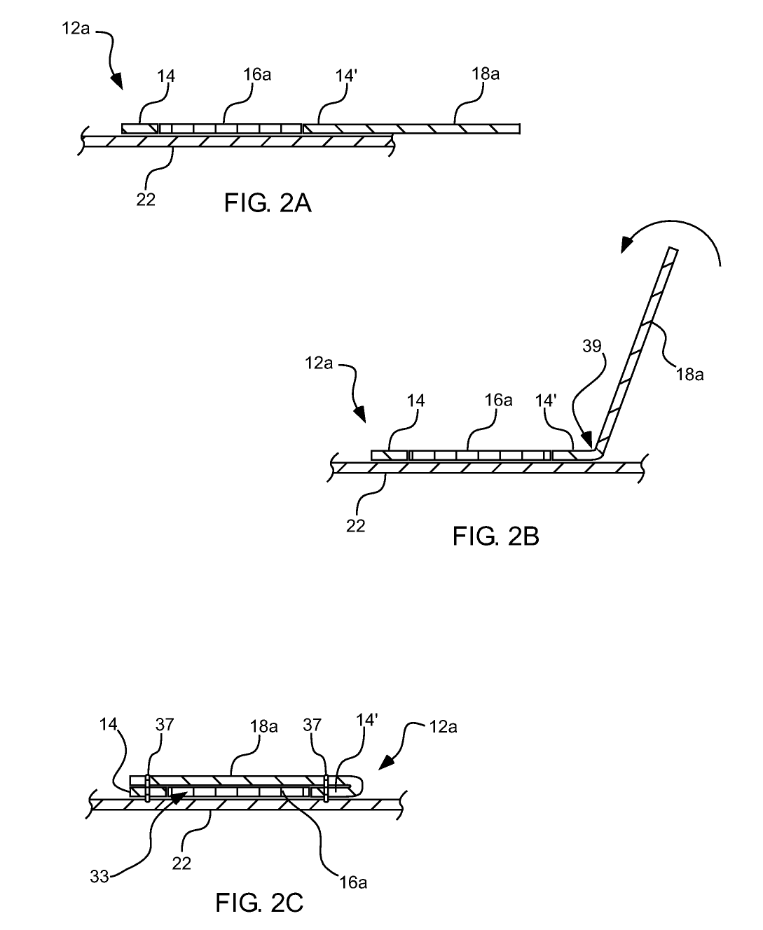

As illustrated in FIGS. 1A and 1B, the present invention provides a reusable closure assembly for attachment to a container. The closure assembly can include a slide assembly, shown generally at 12a, 12b that can include one or more lateral channel portions 14, 14′, and a slidable portion 16a, 16b that can be rupturably coupled to each of the lateral channel portions between the lateral channel portions. A cover portion 18a, 18b can extend laterally from one of the lateral channel portions. The cover portion can be sized and shaped to be folded over the lateral channel portions and the slidable portion to thereby form a top of a three-sided slide enclosure (best appreciated in FIG. 2C, discussed in more detail below). The slidable portion can be slidable within the slide enclosure after being ruptured from the lateral channel portions.

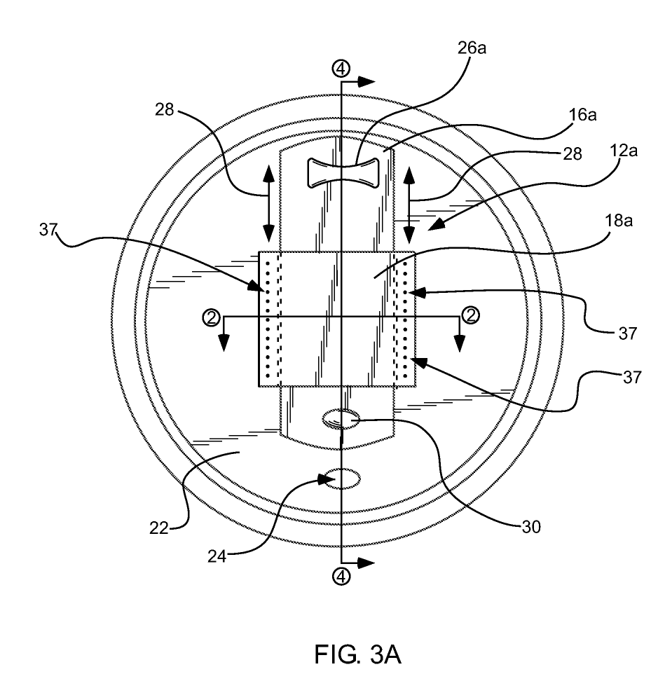

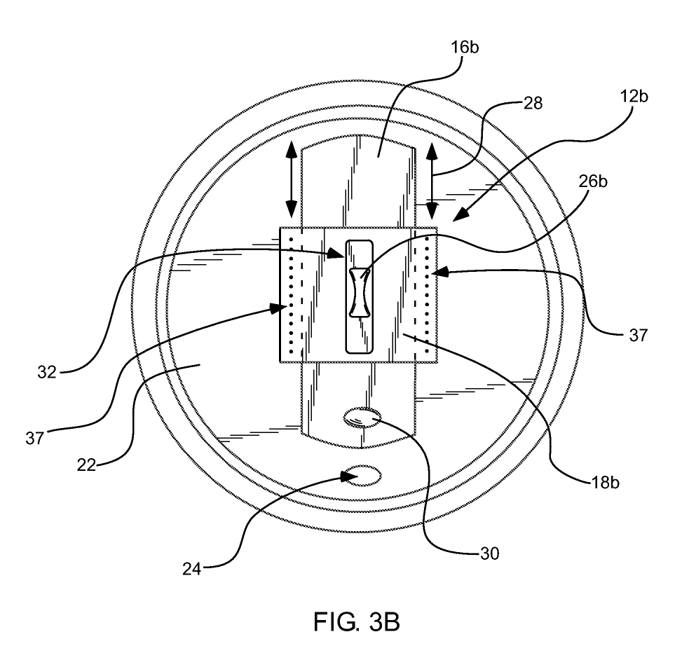

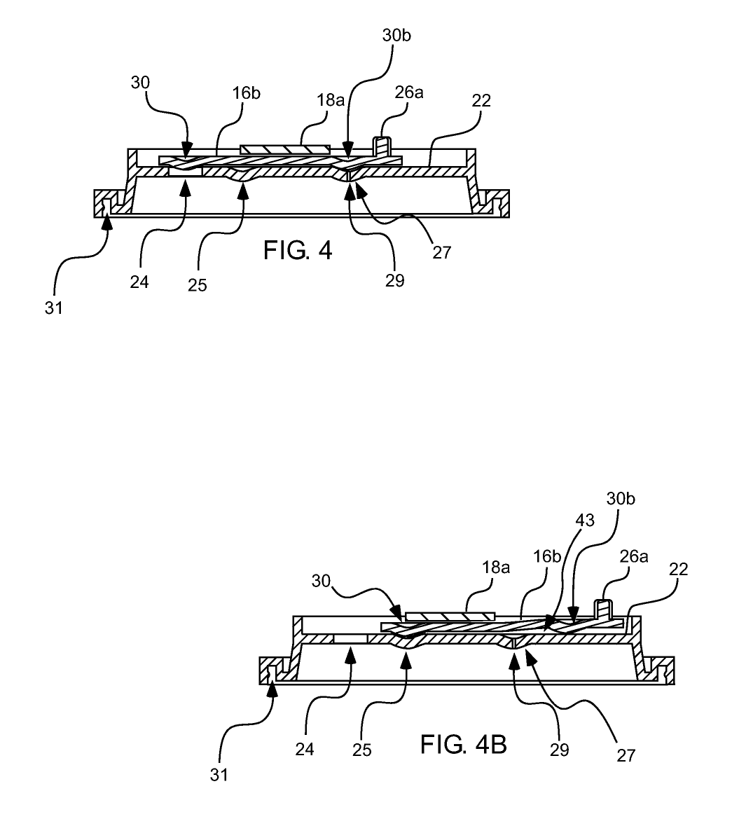

The slide assembly 12a, 12b can be utilized to provide a reusable (e.g., reclosable) closure that can be used in connection with a variety of containers to provide a method by which consumers can “open” the container to dispense material from the container, then “close” the container to prevent inadvertent dispensing of the material from the container. In most cases, the reclosable closures of the present invention will be positioned adjacent a dispensing orifice (such as orifice 24 in lid or cap 22 of FIGS. 3A, 3B and 4) to allow a consumer to selectively cover and/or uncover the orifice. Thus, when a container is referred to herein as “open,” it is to be understood that the condition being described is that in which an orifice formed in the container is not completely covered by any portion of the reusable closure. Similarly, when a container is referred to herein as “closed,” it is to be understood that the condition being described is that in which the orifice formed in the container is covered by some portion of the reusable closure, and materials are restricted or prevented from flowing through the orifice.

The reusable closures of the present invention can be incorporated into a variety of known container configurations including, without limitation, boxes, cylinders, cartons, bags, and cups, etc., as well as lids, covers or caps that can be positioned on the boxes, cylinders, cartons, bags, cups, etc. In one aspect of the invention, the reusable closures can be configured for attachment to a lid of a beverage cup. In such a situation, a portion of the closure at issue (generally the “slide portion,” as discussed in more detail below) will be moveable into and out of position over an orifice formed in the lid of the beverage cup to “open” and “close” the orifice.

In other embodiments of the invention, the closures can be attachable to portions of containers such as boxes, bags, cylinders, in a variety of locations on the containers and a portion of the closure can be moveable to open or close an orifice formed (or formable) in the containers. The present closures can be used in connection with containers configured to store and dispense liquids, pastes, powders, granules, pellets, particles, etc. The containers (or lids or caps of the containers) with which the closures can be utilized can be formed from paper goods, polymers, metals, etc., and can be relatively flexible or relatively rigid.

In the embodiments illustrated in FIGS. 1A and 1B, the slidable portion 16a, 16b is coupled between the lateral channel portions 14, 14′ by material strands defined by two or more perforations 20 formed in the slide assembly 12a, 12b. Thus, the perforations 20 define one or more connecting threads that maintain connection between the slidable portion and the lateral channel portions during typical handling conditions. The two or more perforations can ensure that the slidable portion does not become separated from the remainder of the slide assembly prior to the time at which it is intended the slidable portion be moved, which, as discussed below, is generally after the container carrying the closure has been acquired by an end user.

This aspect of the invention can advantageously be used to provide a hot beverage to consumers in a relatively safely sealed configuration. For example, a restaurant proprietor can provide a cup of coffee to an end used (e.g., consumer) with the cover “locked” and/or secured in a closed configuration, either by way of the rupturably sealed embodiments, or other interlocking structure discussed herein that enables the slidable portion to be “locked” in a closed position. To access the coffee, the end user would have to move the slidable portion from a closed position to an open position.

Thus, the present invention can serve to provide a safer beverage container, as the lid remains locked or securely closed until the end user desires to open and positively acts to do so. In addition, the present invention can limit liability on the proprietor's part from spills of hot beverages that might be due to spillage from an “open” beverage container, as the proprietor can be sure that all beverages provided to end users are provided in a locked, closed configuration.

The perforations 20 can be of a variety of sizes, shapes, density, etc., and are not limited to the generally slit-like geometry illustrated in the figures. In one embodiment of the invention, the perforations include micro-perforations that can be formed in the slide assembly by methods well known to those of ordinary skill in the art. The perforations can be formed during the process in which the overall shape of the slide assembly is cut, punched or otherwise separated from a larger blank or sheet of material (not shown).

The blank or sheet material (not shown) from which the slide assembly can be formed can include a wide range of available materials, including paperboard, paper, plastic, metals, and similar materials capable of being formed and manipulated as described herein. In one aspect of the invention, the slide assembly is formed of material different than a material of the container (or lid or cap of the container) on which the slide assembly is to be attached. In other embodiments of the invention, the slide assembly is formed from the same material as the container or container lid.

While the embodiments of the invention illustrated in FIGS. 1A-5 include a slidable portion 16a, 16b rupturably coupled to one or more lateral channel portions 14, 14′, in one embodiment of the invention, the slidable portion need not be coupled to the lateral channel portions. In this embodiment, the slidable portion can be rupturably coupled to the container (or lid or cap of the container) and can be disengaged from the container or lid by a consumer when it is desired to move the slidable portion into a particular position. The slidable portion can be rupturably coupled to the container or lid, for example, by way of a “spot” of adhesive that can maintain the slidable portion in an initial position but that is not sufficiently robust to prevent the slidable portion from later being released by a consumer.

One advantage to rupturably coupling the slidable portion 16a, 16b to the lateral channel portions 14, 14′ by way of a series of perforations lies in the fact that, once ruptured, the perforations create a series of finger-like projections (not shown) on lateral sides of the slidable portion and the lateral channel portions.

Once created during the rupturing process, these projections create an interference fit between the slidable portion and the lateral channel portions that serves to at least partially restrain movement of the slidable portion between the lateral channel portions.

By only partially restraining movement of the slidable portion, the slidable portion can be relatively easily manipulated by a consumer, yet tends to remain in a desired position when not being manipulated by the consumer. Thus, in one embodiment of the invention, the slidable portion 16a, 16b includes an outer cross section that substantially matches, or corresponds to, an internal cross section of the slide enclosure. In this manner, the slidable portion can be restrained from movement in directions other than the slide path defined by the slide enclosure.

In addition to being rupturably coupled to the lateral channel portions 14, 14′ by way of one or more perforations and/or connecting threads, the slidable portion 16a, 16b can be rupturably coupled to the lateral channel portions in a number of alternate manners. For example, the slidable portion can be removably bonded to the lateral channel portions, or can be removably attached to the lateral channel portions by way of adhesive tape, etc., as would occur to one having ordinary skill in the art having possession of the present disclosure.

FIGS. 2A through 2C illustrate stages of a typical application of a closure 12a of the present invention to a container 22. As shown in FIG. 2A, the closure can first be disposed over the container (or a portion of the container, or a lid or cap of the container) in the generally flat or planar orientation illustrated in FIG. 1A. The cover portion 18a can then be folded over each of the lateral channel portions 14, 14′ and the slidable portion 16a, as illustrated by FIG. 2B (a fold crease 39, FIGS. 1A and 1B, can optionally be formed in the slide assembly to aid in accurately or easily folding the cover portion near the lateral channel portion 14′). Once the cover portion is in the position illustrated in FIG. 2C, the lateral channel portions and the cover portion can be attached to or joined with the container 22 to secure the closure 12a in position on the container (note that the slidable portion of the closure will generally be positioned adjacent a dispensing orifice (not shown in FIGS. 2A through 2C) formed or formable in the container 22).

It will be appreciated that the cover portion 18a and the lateral channel portions 14, 14′ cooperate to form or define a slide enclosure (shown generally at 33 in FIG. 2C) within which the slidable portion 16a can slide. In the embodiment shown in FIG. 2C, the slide enclosure is an area defined by inner sides of the lateral channel portions, cover portion and the upper surface of the container 22 (the area that is shown substantially consumed by the slidable portion 16a). Prior to attachment of the slide assembly 12a to a container, the slide enclosure is essentially three-sided, with the cover and each of the lateral channel portions each comprising one side of the enclosure. Once the slide assembly is attached to a container, the surface of the container to which the slide assembly will be attached becomes the fourth side of the slide channel. In this manner, the slidable portion is nearly completely restricted from movement in directions other than the direction corresponding to a path orthogonal to the plane of FIG. 2C (e.g., “into” and “out of” FIG. 2C).

While the figures generally illustrate a slide assembly 12a, 12b that includes a pair of lateral channel portions 14, 14′, it is to be understood that the present invention can utilize only a single lateral channel portion that borders the slidable portion on one side, while the cover portion can be attached to the container or container lid on the other side to thereby restrain movement of the slidable portion on the other side. For example, in this embodiment (which is not shown in the figures), the lateral channel portion 14 of FIG. 2C could be omitted and the cover portion 18a could be attached directly to the container 22 adjacent the slidable portion 16a. In this manner, the cover portion would serve essentially the same purpose as the lateral channel portion 14.

The slidable portion 16a, 16b, can remain attached to the lateral channel portions 14, 14′ (via material strands defined between the array of perforations 20, for example) during the entire folding and attaching process described immediately above. Thus, in the configuration illustrated in FIG. 2C, the slidable portion remains attached to the lateral channel portions until it is desired that the slidable portion be disengaged from the remaining portions of the closure 12a, 12b for use by a consumer (e.g. end user). For example, in one embodiment of the invention, the closure 12a can be attached to a container lid 22 in the “open” position shown in FIG. 3A. A consumer can attach the lid 22 to a beverage cup (not shown) after filling the beverage cup with coffee, tea, hot chocolate, etc. As is known in the art, the lid or cap 22 can include sealing structure (31 in FIG. 4) to enable the lid or cap to be securely attached to a container, such as a beverage cup or like structure. In one embodiment of the invention, the sealing structure can form a substantially liquid-tight seal over the beverage cup.

The lateral channel portions 14, 14′ and the cover portion 18a, 18b can be attached to the container 22 in a variety of manners. In one aspect of the invention, shown in FIGS. 2A-2C and 3A, the slide assembly 12a and the container 22 can be formed of a polymeric material. When it is desired to attach or join the slide assembly to the container, the lateral channels and cover portion can be attached to or joined with the container or container lid by way of plastic welding, sonic welding, etc., illustrated schematically by welds 37 (FIGS. 2C, 3A and 3B).

In addition to welding the slide assembly components to the container, the components can be attached by way of adhesive, cement, mechanical fasteners, etc., as would occur to one having ordinary skill in such art and having possession of the present disclosure. Also, in one embodiment, the cover portion 18a, 18b can be attached over or to the lateral channel portions 14, 14′ simultaneously with the lateral portions, or the lateral portions can be attached in a first operation, with the cover portion being attached at a later time or procedure.

In one embodiment, the container lid or cap 22 can be installed over the beverage container (not shown) with dispensing orifice 24 covered by a portion of the slidable portion 16a (as shown, for example in FIG. 4). At the point of sale, the end user can grasp engagement structure or nub 26a and separate (e.g., “tear”) the slidable portion from the lateral channel portions 14, 14′, at which point the slidable portion is free to slide within the enclosure formed by the lateral channel portions and the cover portion until at least a portion of the orifice 24 is not covered by the slidable portion, allowing the consumer to dispense the beverage through the at least partially “open” orifice (as illustrated by the “open” position of the slidable portion in FIG. 3A). Of course, the container or cap can also be provided to the end consumer with the slidable portion 16a initially in the “open” position, and an end user would separate the slidable portion from the remainder of the closure system in order to “close” the orifice.

As shown by directional indicators 28 (FIGS. 3A, 3B and 4), once the slidable portion 16a, 16b has been disengaged from the lateral channel portions 14, 14′, the slidable portion can be moved within the enclosure formed by the lateral channel portions and the cover portion to selectively cover and uncover the dispensing orifice 24. In this manner, the consumer can easily expose the dispensing orifice to dispense the beverage when desired: then cover the dispensing orifice to prevent inadvertent spillage of the beverage.

The slidable portion 16a, 16b of FIGS. 3A and 3B can include one or more protrusions 30 that can aid in mechanically “locking” the slidable portion in a “closed” position over the dispensing orifice 24 to limit or prevent inadvertent opening of the container 22. The protrusion can be formed in a variety of shapes and sizes and in one embodiment, illustrated in FIG. 4, the protrusion 30 can be shaped substantially the same as the dispensing orifice 24 to provide a good seal when positioned over (and, in some embodiments, partially within) the dispensing orifice.

As also illustrated in FIG. 4 and FIG. 4B, in one aspect of the invention, structure is provided to facilitate “locking” or securing the slidable portion in both a first, closed position (FIG. 4), and a second, open position (FIG. 4B). In this embodiment, the base can include material dispensing orifice 24, and first detent 25 and second detent 27. A vent orifice 29 can be formed within or adjacent the second detent 27. The slidable portion 16b can include a downwardly extending protrusion 30b. As shown in FIG. 4, when the slidable portion 16b is in a first, closed position, each of the downwardly extending protrusions 30, 30b serve to “lock” or secure the slidable portion in the closed position as protrusion 30 engages the material dispensing orifice 24 and protrusion 30b engages the detent 27.

When an end user wishes to expose (or “open”) the material dispensing orifice 24 to dispense the beverage, he or she can slide the slidable portion 16b into the open position shown in FIG. 4B. In this position, the protrusion 30 engages the detent 25 to secure or lock the slidable portion in the open position. In this manner, the slidable portion 16b can be held more securely in one position or another until the end user wishes to adjust the slidable portion. When not being used for drinking, the end user can “lock” the slidable portion in the closed position and it will remain closed until the user slides the slidable portion into the open position of FIG. 4B.

In addition, as shown in FIG. 4, when the slidable portion 16b is in the closed position, the protrusion 30b engages the detent 27 and also closes off the vent orifice 29. Thus, when the slidable portion is in the closed position, the vent orifice is automatically closed to prevent or limit spillage from the vent orifice. By closing or sealing the vent orifice, spillage from other portions of the container (e.g., from the material dispensing orifice) is also limited, as airflow is restricted through the vent orifice such that liquid flow through other portions of the container will also be restricted.

When the slidable portion is moved into the open position, protrusion 30b rides along the upper surface of the base and creates a gap 43 between the upper surface and the protrusion, as shown in FIG. 4B. In this manner, the vent orifice is “opened” when the slidable portion is opened, facilitating free-flow of beverage through the material dispensing orifice. The present invention thus provides a securely closable system that limits or prevents spillage when the slidable portion is closed, yet also provides an open dispensing orifice and open vent structure for use when the slidable portion is in the open position.

While the embodiments illustrated in FIGS. 4A and 4B include detents 25 and 27 formed in the base of the lid, and protrusions 30 and 30b formed in the slidable portion 16b, it is to be understood that the detent/protrusion relationship can be inverted. For example, the slidable portion can include one or more detents while the base of the lid can include upwardly extending protrusions.

The engagement structure 26b of FIGS. 1B, 3B and 5 can take a variety of forms and can be attached to or formed with the slidable portion 16b in a number of manners. As discussed in more detail below, the engagement structure can be a nub formed or attached to the slidable portion near a middle portion of the slidable portion and can extend through the cover portion 18b. The engagement structure can also comprise an opening or detent or protrusion (not shown) formed in the slidable portion to enable a consumer to manipulate the slidable portion. The engagement structure can include frictional components (not shown) formed or attached thereto to enhance a gripping interface between the engagement structure and a consumer's finger. The frictional component can include, without limitation, a series of ridges, bumps, dimples, textural irregularities, and/or similar features that can increase a consumer's “grip” on the engagement structure.

In the embodiment of the invention shown in FIGS. 1B, 3B and 5, the slidable portion 16b includes engagement structure 26b and the cover portion 18b includes a receiving opening 32 configured to receiving the engagement structure 26b. Thus, as the cover portion is folded, or otherwise positioned, over the slidable portion 16b, the engagement structure 26b extends through (or is otherwise accessible through) the receiving opening 32.

In this embodiment, a consumer can manipulate the slidable portion by grasping or contacting the engagement structure and sliding the engagement structure within the receiving opening. This embodiment of the invention is advantageous in that the engagement structure is centrally located relative to the closure assembly 12b, and in that the slidable portion is even further restrained to a particular slide path relative to the remaining portions of the closure once disengaged therefrom. This can aid in ensuring that the slide portion, once positioned over the dispensing orifice, is not subject to significant lateral movement, possibly resulting in inadvertent spillage of the material contained within the container.

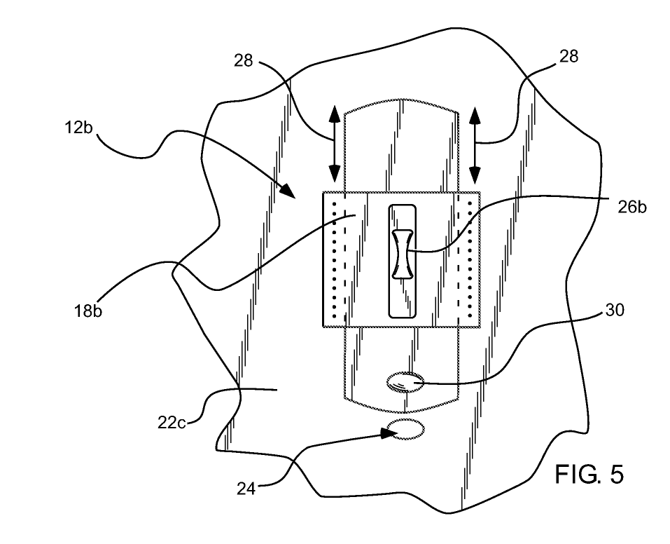

FIG. 5 illustrates a generic container 22c on which slide assembly 12b has been attached. It will be appreciated that the present invention is adapted to be utilized with a variety of container shapes and sizes, as the present closures do require specialized structure be attached to or included in the container 22c in order to receive the components of the slide assembly 12b. In other words, the present closure can be attached to nearly any surface of a container, and need not be disposed adjacent edges of the container (i.e., needn't “wrap-around” corners of the container), as is the case with many conventional closure systems.

In addition to the structural and procedural considerations discussed above, the present invention also provides a method of providing a container with a reusable closure, comprising: disposing a slide assembly on the container adjacent a portion of the container from which material will be dispensed from the container, the slide assembly including: a pair of opposing, lateral channel portions; a slidable portion rupturably coupled between the lateral channel portions; and a cover portion, extending over the lateral channel portions and the slidable portion; attaching each of the lateral channel portions to the container; and selectively coupling the cover portion to the lateral channel portions or to the container to form a four-sided enclosure in which the slidable portion can slide adjacent the container after being ruptured from the lateral channel portions.

Coupling each of the lateral channel portions to the container can include joining the lateral channel portions with the container, and can include simultaneously joining the lateral channel portions and the cover portion with the container.

Coupling each of the lateral channel portions to the container can include coupling each of the lateral channel portions to a substantially uninterrupted, continuous surface of the container.

The present invention also provides a method of providing a reusable closure to a container lid, the container lid having attachment structure associated therewith for attaching the lid to the container and having a material dispensing orifice formed or formable therein. The method can include disposing a slide assembly on the container lid adjacent the material dispensing orifice, the sliding assembly including: at least one lateral channel portion; a slidable portion rupturably coupled to the lateral channel portion; and a cover portion, foldably extending from the lateral channel portion. The method can include attaching the lateral channel portion to the container lid, and selectively attaching sections of the cover portion to the lateral channel portion, or to the container lid, to form a four-sided enclosure in which the slidable portion can slide adjacent the container lid after being ruptured from the lateral channel portion.

The method can include simultaneously joining the lateral channel portion and the cover portion with the container lid.

The present invention also provides a method of making a reusable closure assembly for use on a container, including: obtaining a blank of material; forming rupturable sections in the blank of material to delineate in the blank of material: a pair of opposing, lateral channel portions; and a slidable portion between the lateral channel portions; and forming a cover portion in the blank of material, the cover portion being sized so as to be foldable over each of the lateral channel portions and the slidable portion.

Forming rupturable sections in the blank of material can include forming a series of perforations in the blank of material. The rupturable sections can be formed in the same procedure in which the blank of material is formed, or during a different procedure or a different time than the blank of material is formed.

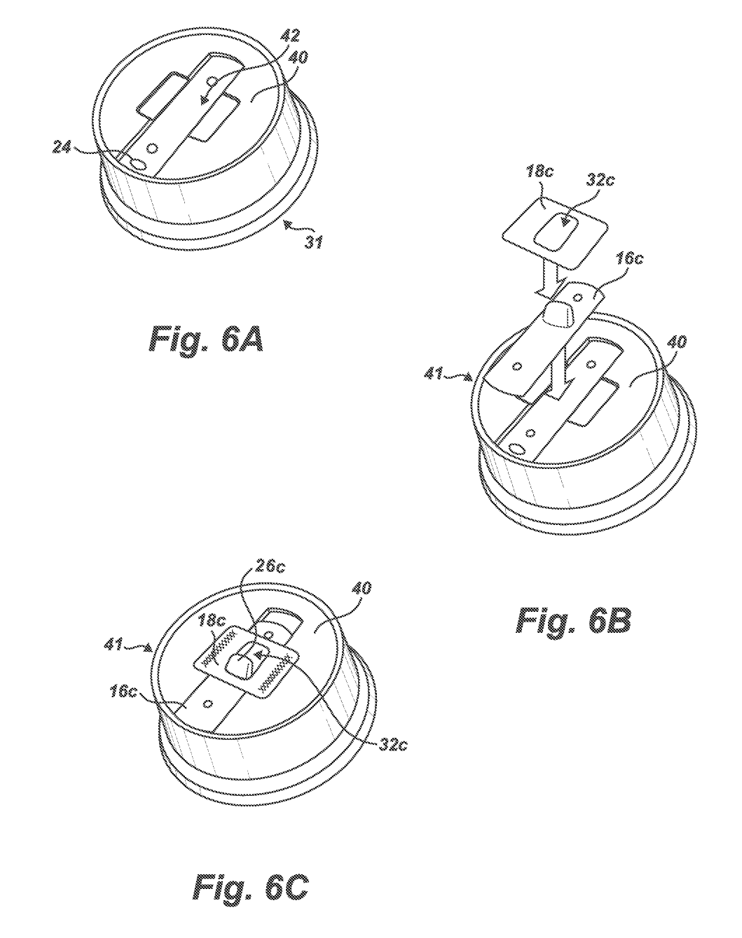

Turning now to FIGS. 6A through 9, further embodiments of the invention are illustrated. These embodiments of the invention can be utilized to provide a reusable or reclosable lid for use on beverage containers, such as coffee cups and the like. In these aspects of the invention, the use of two or more components that are rupturably coupled to one another is not necessarily a component of the invention. FIG. 6A illustrates a lid base 40 that includes attachment structure (similar to the structure 31 illustrated in FIG. 4) associated therewith for attaching the base to the container. A material dispensing orifice 24 can be formed or formable therein.

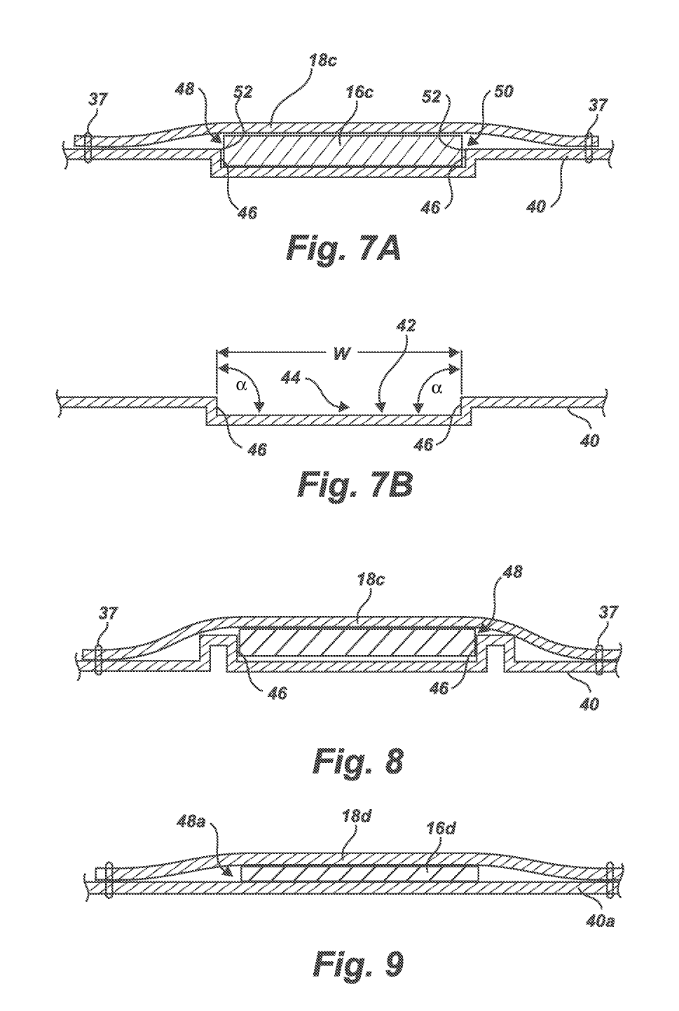

A slide channel 42 can be formed as part of the base 40. The slide channel can include an open top section (44 in FIG. 7B) defined and/or formed by or between a pair of sidewalls 46. As best appreciated from FIG. 7B, the open top section 44 can have an opening width “W” that is equal to or greater than a narrowest width defined between the pair of sidewalls. A slidable portion 16c can be slidably disposed within the slide channel and can be movable at least partially over the material dispensing orifice 24. A cover portion 18c can be attached to the base and can form a top of a slide enclosure (the slide enclosure being shown generally at 48 in FIGS. 7A and 8) for the slidable portion.

By forming the open section 44 with an opening width “W” equal to or greater than a narrowest width defined between the pair of sidewalls, the slidable portion can be insertable into the slide channel 42 from above the slide channel. In this manner, the slidable portion is generally free, but for the cover portion 18c, to move upwardly and downwardly into and out of the slide channel. This configuration allows the slidable portion to be inserted or installed within the slide channel at a variety of times during the manufacturing process.

In contrast, many conventional container lids that include slide channels in which a slide travels include sidewalls that converge over the slide (e.g., overhang or angle inward over the slide) in order to retain the slide within the slide channel. While such arrangements have been used with some success, the overhanging, or inwardly angling, portions of the sidewalls require that the slide be inserted lengthwise into the slide channel. Not only can this add significantly to the complexity and cost of assembling the lid, the cost of manufacturing or forming the base of the lid can be increased significantly, as the overhanging or inwardly angling sidewalls must be formed in a relatively complex operation. For example, by attempting to manufacture a lid base having a slide channel with overhanging sidewalls, molding is made more difficult due to the “inside” angles that must be formed for such a geometry.

In the aspect of the present invention illustrated in FIGS. 6A through 9, however, the sidewalls 46 are positively cambered relative to the slide channel (or are “neutrally” cambered relative to the slide channel), such that the slidable portion 16c can be installed within the slide channel from above the slide channel. In other words, each of the angles “a” illustrated in FIG. 7B are about 90 degrees or greater. Once the slidable portion is positioned within the slide channel, the cover 18c can be installed over the slidable portion and the slide channel and can be attached to an upper surface of the base 40. In this manner, the sidewalls (and the slide channel) can be relatively easily formed in the lid base 40 during conventional manufacturing processes such as injection or thermoform molding.

While the sidewalls 46 are shown in FIGS. 7A through 8 as being substantially vertical (such that the opening width “W” is the same as the narrowest width defined between the walls), it is to be understood that the sidewalls can be curved or angled in a variety manners. For example, the sidewalls might each “bow” outwardly such that a narrowest portion is defined at a vertical midpoint of the sidewalls, with greater width portions defined below and above the midpoint section. Nevertheless, in such an arrangement, the opening width “W” would still be greater than the narrowest width defined between the sidewalls such that the slidable portion could be installed past the opening width “W” portion and into the lower portion of the slide channel between the sidewalls.

In the embodiments illustrated in FIGS. 7A and 7B, an upper section 50 of the slidable portion 16c can extend above an upper section 52 of each of the sidewalls 46 so as to protrude above the slide channel 42 to contact an underside of the cover portion 18c. In this manner, as the cover portion 18c is coupled or welded to the upper portion of the base 40, the cover portion contacts and applies a downward force to the slidable portion to serve as a partial “brake” to the slidable portion. In this manner, the slidable portion tends to remain in place when a consumer is not adjusting a position of the slidable portion.

In the embodiments shown wherein the cover portion 18c, 18d is curved over the slidable portion 16c, 16d, it is generally the case that the cover portion is initially formed in a flat, planar configuration and the edges of the cover portion are pulled downwardly around the slidable portion when the cover portion is attached to the lid base 40, 40a. As welds 37 join the cover portion to the base, the cover portion is tensioned over the slidable portion. In this manner, a nearly constant braking interface is provided between the cover portion and the slidable portion. It is to be understood that the locations of the welds 37 shown in FIGS. 7A, 8 and 9 are for exemplary purposes, and that the welds may be positioned closer or further from the slidable portion than is illustrated. In addition, the welds may be located immediately adjacent the sidewalls in FIG. 8, such that little or none of the cover portion extends beyond the sidewall peaks illustrated in FIG. 8.

In addition to the configuration illustrated in FIGS. 7A and 7B, as shown in FIG. 8, in one aspect of the invention the sidewalls 46 can extend above an upper surface of the base, and a bottom of the slidable portion can slide on (or in the same plane as) the upper surface of the base. In other words, in this embodiment of the invention, a lowermost portion of the slidable portion slides along the same plane as the uppermost portion of the lid base 40, with the sidewalls extending upwardly from the plane.

As shown in FIG. 6C, the slidable portion 16c of the lid 41 can include engagement structure 26c associated therewith. The engagement structure can enable a user to more easily engage the slidable portion to manipulate the slidable portion over the upper surface of the base 40. Also, cover portion 18c can include a receiving opening 32c formed therein to expose the engagement structure of the slidable portion to enable the user to access the engagement structure through the cover portion.

The various components of the completed or assembled lid 41 (shown in FIG. 6C) can be formed from a variety of materials, including paper products, paperboard, cardboard, plastics, polymers, etc. In one embodiment, each of the base 40, the slidable portion 16c and the cover portion 18c are formed as separate units (e.g., pieces) of material and are all formed from a polymeric material that is well suitable for welding, including, without limitation, ultrasonic welding techniques. In this manner, the cover portion can be welded to the base by welding techniques known to those of skill in such art.

Turning now to FIG. 9, a further embodiment of the invention is illustrated. As shown, in this aspect of the invention, the base 40a of the lid does not include a slide channel for the slidable portion 16d, rather, the slidable portion 16d is free (but for the restraining forces imposed by the cover portion 18d) to move in any direction on the upper surface of the base. In this embodiment, the cover portion 18d is welded to the base and provides slide enclosure (shown schematically at 48a) after it is welded to the base 40a. In this manner, the slidable portion 16d is substantially restricted to movement on (or across) the base in a single degree of freedom.

As used herein, the terms “degrees (or degree) of freedom” are used in the context of six total degrees of freedom being possible for a rigid body in space. The six degrees of freedom are commonly known as three translational degrees of freedom in each of three axes in space, with three additional degrees of freedom provided by rotation about each of the three axes in space.

Thus, in this embodiment, the slidable portion 16d, but for the cover portion 18d, is free to slidably move relative to the base 40a in two degrees of freedom. After attachment of the cover portion, however, the slidable portion is restricted to movement in substantially only a single degree of movement, backward and forward over the base 40a. This aspect of the invention provides a number of advantages over the prior art, include, perhaps most noticeably, ease of manufacture and low-cost manufacture. In this embodiment, substantially any type of base can be utilized and it need not be tailor-made for the present application but can include a simple, planar top. All that need be done to incorporate the present system with such a lid base is to place the slidable portion over the lid base, orient the slidable portion so that movement of the slidable portion covers and uncovers a material dispensing orifice formed in the lid base, and welding the cover portion over the slidable portion and to the base to restrain the slidable portion to the desired direction of movement.

While the embodiments of the invention illustrated above generally include a base with a flat, planar upper surface, it is to be understood that the present invention can include a rounded base top, e.g., a base top that is convex or concave relative to the beverage container.

Also, while some embodiments show a slidable portion that fits within a slide channel to restrain the slidable portion to a particular path of travel, it is contemplated that the slide channel can be restrained to a particular path of travel in a number of alternative manners. For example, the slidable portion may slide over the upper surface of the base without sides of the slidable portion being restrained, but the slidable portion may include protrusions (e.g., “fingers”) that fit within narrow channels formed in the upper surface of the lid base. The finger/channel relationship can aid in restraining lateral movement of the slidable portion as it moves over the upper surface of the lid base. Also, the slidable portion may itself include relatively narrow channels in which fingers extending from the upper surface of the base ride.

The present invention also provides a method of forming a lid for use on a container, comprising: obtaining a base configured to be attached to the container; forming a slide channel, including: forming as part of the base a pair of sidewalls defining lateral sides of the slide channel; and defining an open top section of the slide channel between upper portions of the sidewalls; inserting a slidable portion through the open top section and into the slide channel such that the slidable portion is slidably movable within the slide channel; and positioning over the slidable portion a cover portion and attaching the cover portion to the base.

Attaching the cover portion can include welding the cover portion to the base. Attaching the cover portion to the base can also include cinching the cover portion over the slidable portion such that the cover portion provides a braking interface with the slidable portion to at least partially restrict slidable movement of the slidable portion.

Further, a method of forming a lid for use on a container is provided by the present invention, comprising: obtaining a base configured to be attached to the container; disposing a slidable portion in slidable contact with the base; positioning a cover portion over the slidable portion; and attaching the cover portion to the base to thereby form a slide enclosure to substantially restrict the slidable portion to movement in a single degree of freedom.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A method of forming a lid for use on a container, comprising:
obtaining a base configured to be attached to the container;
forming a slide channel, including:
forming as part of the base a pair of sidewalls defining lateral sides of the slide channel; and
defining an open top section of the slide channel between upper portions of the sidewalls;
inserting a slidable portion through the open top section and into the slide channel such that the slidable portion is slidably movable within the slide channel; and
positioning over the slidable portion a cover portion and attaching the cover portion to the base.

2. The method of claim 1, wherein defining the open top section includes defining an opening width that is equal to or greater than a narrowest width defined between the pair of sidewalls.

3. The method of claim 1, wherein attaching the cover portion comprises welding the cover portion to the base.

4. The method of claim 1, wherein attaching the cover portion to the base includes cinching the cover portion over the slidable portion such that the cover portion provides a braking interface with the slidable portion to at least partially restrict slidable movement of the slidable portion.

5. The method of claim 1, wherein the cover portion and the base are formed from a polymeric material.

6. A method of forming a lid for use on a container, comprising:
obtaining a base configured to be attached to the container;
disposing a slidable portion in slidable contact with the base;
positioning a cover portion over the slidable portion; and
attaching the cover portion to the base to thereby form a slide enclosure to substantially restrict the slidable portion to movement in a single degree of freedom.

7. The method of claim 6, wherein attaching the cover portion comprises welding the cover portion to the base.

8. The method of claim 6, wherein attaching the cover portion to the base includes cinching the cover portion over the slidable portion such that the cover portion provides a braking interface with the slidable portion to at least partially restrict slidable movement of the slidable portion.

9. The method of claim 6, wherein the cover portion and the base are formed from a polymeric material.

10. A lid for use on a container, comprising:
a base, having attachment structure associated therewith for attaching the base to the container;
a material dispensing orifice formed or formable in the base;
a vent orifice formed or formable in the base;
a moveable section including blocking structure operable to at least partially block both of the material dispensing orifice and the vent orifice; and
wherein movement of the moveable section effectuates:
simultaneous blockage of the material dispensing orifice and;
simultaneous unblocking of the material dispensing orifice and the vent orifice.

11. The lid of claim 10, wherein the moveable section comprises a rotatable portion, and wherein the blocking structure blocks both the material dispensing orifice and the vent orifice when the rotatable portion is in a first position and unblocks both the material dispensing orifice and the vent orifice when the slidable portion is in a second position rotatably removed from the first position.

12. The lid of claim 10, wherein the moveable section comprises a slidable portion, and wherein the blocking structure blocks both the material dispensing orifice and the vent orifice when the slidable portion is in a first position and unblocks both the material dispensing orifice and the vent orifice when the slidable portion is in a second position slidably removed from the first position.

13. The lid of claim 12, further comprising a pair of detents formed in the base, one of the detents operable to at least partially secure the slidable portion in the first position and one of the detents operable to at least partially secure the slidable portion in the second position.

14. The lid of claim 13, wherein one of the detents is formed adjacent the material dispensing orifice and wherein the detent is operable to at least partially secure the slidable portion in the first position and is operable to at least partially block the material dispensing orifice to limit spillage of the material from the material dispensing orifice.

15. The lid of claim 13, wherein one of the detents is formed adjacent the vent orifice and wherein the detent is operable to at least partially secure the slidable portion in the first position and is operable to at least partially unblock the vent orifice when the slidable portion is in the second position.

16. The lid of claim 15, wherein the detent at least partially unblocks the vent orifice by sliding across an upper surface of the base and creating a gap between the slidable portion and the vent orifice.
